(19) United States
(12) Patent Application Publication
(10) Pub. No.: US 2017/0186068 A1
(43) Pub. Date: Jun. 29, 2017

(54) IN-STORE PORTABLE LOCATION-AWARE SHOPPING AND MERCHANDISING SYSTEM

(71) Applicant: AuVitCus Inc., Grover Beach, CA (US)

(72) Inventors: Robert James Dumouchel, Arroyo Grande, CA (US); Marvin E. Byrd, III, Nipomo, CA (US); Rachel Chadwell, Pismo Beach, CA (US); Michael Boyer, Arroyo Grande, CA (US)

(21) Appl. No.: 14/980,621

(22) Filed: Dec. 28, 2015

(51) Int. Cl. G06Q 30/06; G06K 7/10; G06Q 30/02; H04N 5/225

(52) U.S. Cl. CPC G06Q 30/0625; G06Q 30/0633; G06Q 30/0639; G06Q 30/0643; H04N 5/225; G06K 7/10861; G06Q 30/0261

(57) ABSTRACT

An in-store portable location-aware shopping and merchandising system, including a portable shopping and merchandising device including a processor, memory, a shopping cart software application module, light sensor, a communication module and a display screen. The portable shopping and merchandising device is configured to update a location of the portable shopping and merchandising device as it traverses a store, and displays location-specific information about store items to the shopper. A recipe is selected from a recipe database, and information regarding the recipe ingredients is updated as the location of the portable shopping and merchandising device changes.

### BACKGROUND OF THE INVENTION

Field of the Invention

The present invention relates generally to portable computing devices for use in a store, and more specifically to portable computing system configured to track the location of the portable computing device in the store.

Discussion of the Related Art

Retail food stores usually have prepared signage affixed to the shelves, end caps, aisle markers, shopping carts, and other areas within the store. These signs provide communication of the contents of the store and promotional information related to those products. Retail stores have long understood that these signs increase product sales by increasing customer awareness of the products.

Many shoppers go to a supermarket with a prepared list. Most shoppers refer to the weekly flyer mailed to their home from their local supermarkets to learn about sale prices, other special offers and to clip “store” coupons. “Store” coupons are promotional consideration documents valid only in the store from which they are offered, whereas packaged goods manufacturers' coupons are valid at any retail store which carries the product and accepts coupons.

The handwritten shopping list is the most common form of reminder for shoppers Many shoppers organize their coupons in pocketbook type folders with dividers indicating the type of product, such as “dairy” or “frozen.” Shopping lists usually are prepared using generic terms such as “cereal” unless a specific brand is wanted, or a brand corresponds to a discount coupon or special sale price.

Consumers receive thousands of product advertisements and coupons yearly in their mail, magazines and newspapers. To take advantage of the potential savings which coupons offer, a consumer must clip, organize and keep track of all promotional offers on a timely basis.

The competition among supermarkets for the consumer dollar is intense. To attract and maintain customer loyalty, supermarkets offer services such as check cashing privileges, video rentals, non-food products and film processing in addition to food products to keep the shopper coming back to their store. Supermarkets mail weekly advertisements to shoppers in their trading area, offering “sale” prices. Many offer double the face value on packaged goods manufacturers' discount coupons. Additional advertisements appear in newspapers, radio and television. The competition to get a shopper into their supermarket is fierce, and the supermarket wants them to return again and again.

The packaged goods manufacturers whose products are sold in these supermarkets are equally aggressive in trying to influence the customer to purchase their product. The packaged goods manufacturer, however, is not concerned with where his product is purchased. Packaged goods manufacturers also use direct mail, radio, television, newspapers and telemarketing, and most offer discount coupons, rebates and sweepstakes or games to influence the customer's choice. The combination of retailers' and packaged goods manufacturers' direct mail solicitations have been referred to by some as mail box clutter.

These types of promotional efforts by supermarkets and packaged goods manufacturers are primarily directed toward the consumer in his home. Once consumers enter a supermarket, they are farther inundated with products on display and signs everywhere. Signs called “shelf-talkers” protrude from shelves displaying the product, and coupons are made part of the label so that when the product is purchased the shopper is given an immediate discount. Instant coupon machines dispense coupons from the shelf holding the products and free-standing kiosks issue coupons. Other kiosks issue recipes promoting a product, provide directory assistance to locate products within the store, or allow the shopper to scan a product to verify the price.

The advertising and promotional activities on behalf of packaged goods manufacturers in supermarkets are usually implemented and managed by a third party vendor who is paid for these services by the packaged goods manufacturer and who subsequently pays a commission to the supermarket. As for customer shopping assistance, this has been made available in the form of calculators on shopping carts and product finder directory kiosks. Generally, other activities and devices are used solely to promote product sales and are self-serving for the packaged goods manufacturers, supermarkets and third party vendors alike.

Few, if any, customer assistance programs are presently available which enable a shopper to save time and money. A number of states require that each product offered for sale in a retail store have its own individual price tag or sticker. It is difficult for the shopper to check the prices marked on a product or displayed on a shelf label against the prices actually contained in the point of sale system. Hence shoppers can end up paying a different amount than the “sticker” price on the product. Price checking kiosks are available in some stores, but are inconvenient since a kiosk is not located in every aisle. The customer is required to bring a product to a kiosk for scanning and remember a shelf label price if the item is not individually marked or is marked incorrectly.

The effectiveness of advertising on promotional activities is difficult to measure. Supermarkets, for example, redeem billions of packaged goods manufacturers' discount coupons annually and don't know who used them. Supermarkets issue and redeem billions of their own discount coupons and they do not know who these customers are either. A supermarket may average as many as 25,000 shoppers passing through their point of sale aisles per week and they don't know which customer bought what, or what influenced them to purchase what they did buy. Nor do packaged goods manufacturers know what influenced the customer to buy their products.

At home, consumers attempt to organize their purchases for a shopping trip by creating shopping lists of products they need. This is quite prevalent for grocery shopping, and usually carries over to non-food purchasing needs as well. The process often consists of jotting down needed items on a blackboard or piece of paper at random times. This “preliminary” list is then edited into a “final” handwritten list for reference in the supermarket as a reminder of what to purchase. Supermarkets regularly attempt to entice customers to shop in their stores by offering sale prices. The shopping list is usually compared with the specials as advertised in flyers received at home and in newspaper advertisements. If the shopper uses discount coupons, these are usually brought to the supermarket with the list which may be marked to indicate items that have an accompanying coupon.

With the increased popularity of smart phones, the shopper may use a list application or shopping application for creation of the shopping list. In some cases, the shopping application may be a specific store application showing specials and digital coupons.

Some supermarkets have attempted to assist their customers with home shopping systems whereby a customer could complete a grocery order form and transmit the form to the supermarket, which would assemble the products and deliver it to the home. In spite of these isolated efforts, customers receive very little assistance in their shopping activities. Supermarkets present their products to their customers in elaborate displays, but fail to make it easy for the shopper to make an informed choice based upon value and comparison. Shoppers are also confused about which size product to purchase because the method which supermarkets use to display the unit price is, in many cases, purposely confusing.

Shopping display systems, such as that in U.S. Pat. No. 5,250,789 to Johnsen, show a shopping device coupled to a shopping cart that organizes and displays a shopper's shopping list, and is configures to be able to scan individual items and indicate the location of items in the store. The system can also show advertisements in response to the shopper showing interest in store products.

### SUMMARY OF THE INVENTION

In one embodiment, the invention can be characterized as an in-store location-aware shopping and merchandising system comprising: a portable shopping and merchandising device comprising: a processor; a non-transitory memory coupled to the processor; a shopping cart application module configured to run on the processor; at least one light sensor; a communication module communicatively coupled to the shopping cart software application module and the light sensor; and a display screen operatively coupled to the shopping cart application module, wherein the shopping cart application module is configured to perform the steps of: determining a current location of the portable shopping and merchandising device; receiving information about at least one store item, wherein each store item is associated with at least one location; and displaying on the display screen information about at least one of the at least one store item, wherein at least one of the at least one store item is associated with the current location.

In another embodiment, the invention can be characterized as a method for using an in-store location-aware shopping and merchandising system comprising the steps of: determining a current location of a portable shopping and merchandising device, the portable shopping and merchandising device including a processor, a non-transitory memory coupled to the processor, a shopping cart application module configured to run on the processor, at least one light sensor, a communication module communicatively coupled to the shopping cart software application module and the light sensor, and a display screen operatively coupled to the shopping cart application module; receiving, by the portable shopping and merchandising device, information about at least one store item, wherein each store item is associated with at least one location; and displaying on the display screen information about at least one of the at least one store item, wherein at least one of the at least one store item is associated with the current location.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 is a high-level schematic diagram of an exemplary shopping system in one embodiment of the present invention.

FIG. 2 is a schematic diagram of a portable shopping device of the exemplary shopping system.

FIG. 3 is a process flow diagram for displaying a recipe on the portable shopping device in one embodiment of the present invention.

FIG. 4 is an exemplary default recipe information display of the portable shopping device.

FIG. 5 is an exemplary recipe ingredient to shopping list display of the portable shopping device.

FIG. 6 is an exemplary store map display of the portable shopping device.

FIG. 7 is an exemplary store zone recipe ingredients display of the portable shopping device.

FIG. 8 is an exemplary selected product display of the portable shopping device.

FIG. 9 is an exemplary keypad entry display 900 of the portable shopping device.

FIG. 10 is an exemplary keyboard overlay display of the portable shopping device

FIG. 11 is an exemplary embodiment of a high-level process and database schematic diagram of the exemplary shopping system in one embodiment of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention is may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

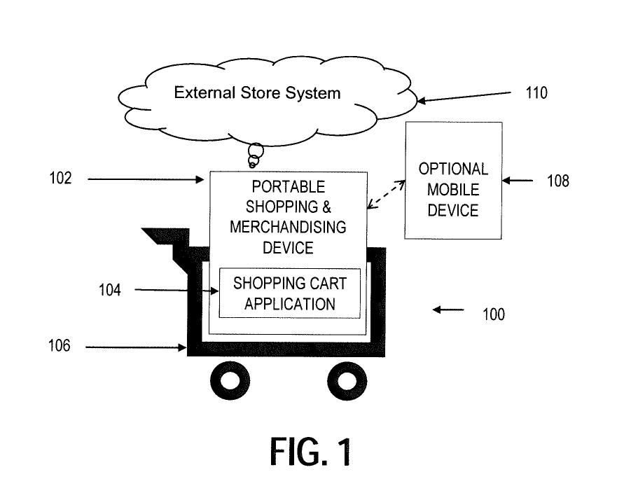

Referring first to FIG. 1, a schematic diagram of an exemplary shopping and merchandising system 100 for use in a store is shown. Depicted area shopping cart 106, a portable shopping device 102 including a shopping cart application module 104, a store system 110 and an optional mobile device 108.

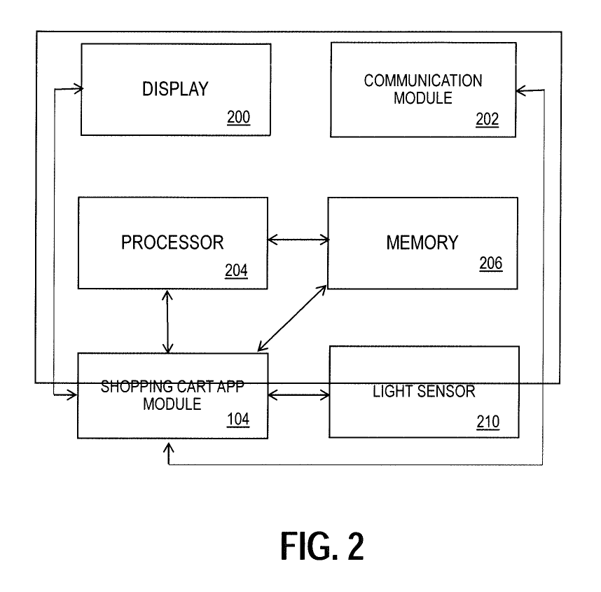

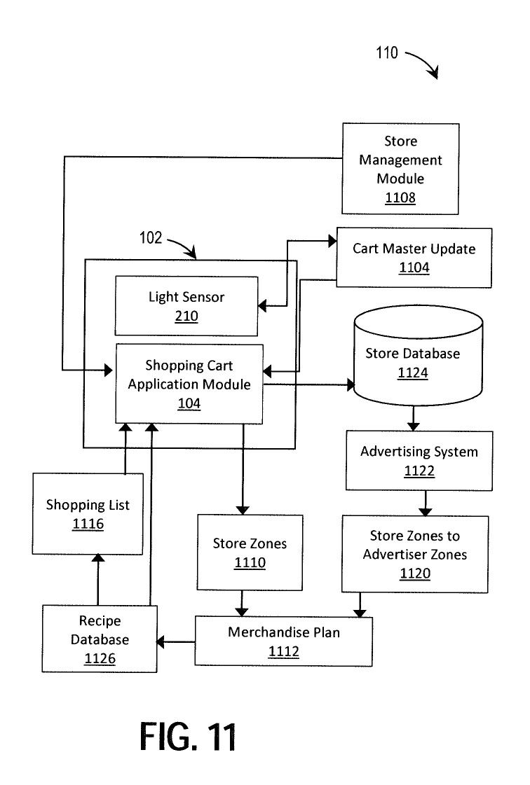

In the In-Store Portable Location-Aware Shopping and Merchandising System 100 shown in FIG. 1, the portable shopping device 102 is communicatively coupled to the shopping cart application module 104. The shopping cart application module 104 is configured to receive information to/from the store system 110 and the portable shopping device 102 such as a location of the portable shopping device 102 in the store. The shopping cart application module 104 can also be configured to send information to the portable shopping device 102, for example, a recipe to be displayed on the portable shopping device 102. The shopping cart application module 104 is described further below in FIGS. 2 and 11

Referring next to FIG. 2, a schematic diagram of the portable shopping device 102 is shown in one embodiment of the present invention. Shown are a display 200, a communication module 202, a processor 204, non-transitory memory 206, the shopping cart application module 104, and a light sensor 210.

The shopping cart application module 104 is configured to run on the processor 204, using the non-transitory memory 206 as required. The non-transitory memory 206 is also used to store data, for example recipes received from an external recipe database 1126. The shopping cart application module 104 is operatively coupled to the display 200, the display 200 being configured to receive input from the shopper. In one embodiment, the display 200 is a touchscreen display. In another embodiment the display 200 includes a keyboard for input. The display 200 is configured to display information received from the shopping cart application module 104, as described further below.

The shopping cart application module 104 is also operatively coupled to the communication module 202. The communication module 202 is coupled to communicate with the shopping cart application module 104 and the optional mobile device 108. The communication module 202 may also be configured to communicate with other external devices and/or networks.

The shopping cart application module 104 is operatively coupled to the light sensor 210. The light sensor 210 is configured to sense ambient light, e.g. a camera, a photo transistor, a charge-coupled device or other element capable of light sensitivity. In some embodiments, the shopping cart application module 104 may also be operatively coupled with at least one of a camera, an accelerometer, a compass, an RF receiver, and a gyroscope.

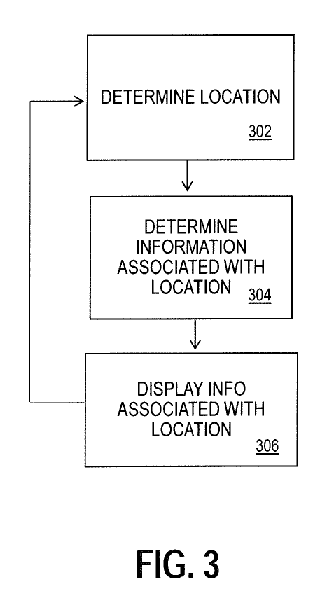

Referring next to FIG. 3, a process flow diagram for displaying a recipe on the portable shopping and merchandising device 102 is shown. A determine location step 302, an optional select recipe step 304, and a display meal recipe step 306 are all depicted.

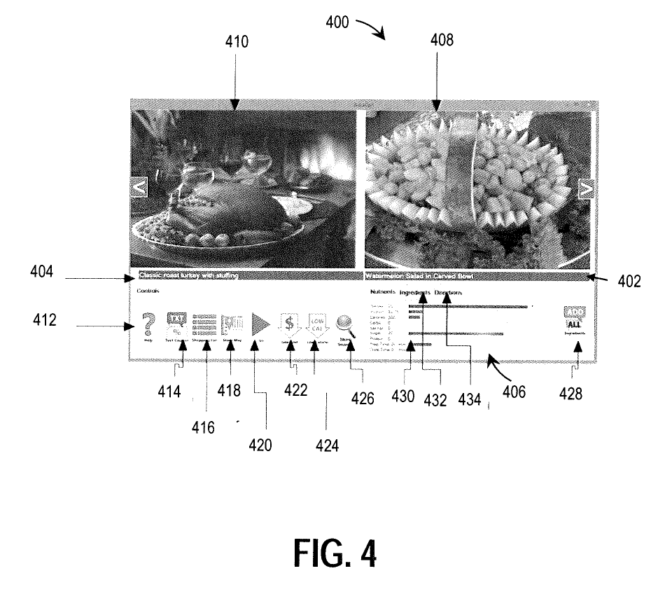

During the first determine location step 302 a current location of the device in the store is determined by the portable shopping device 102. In the select recipe step 304, a first recipe is selected from the external recipe database 1126 queried by the shopping cart application module 104. The recipe may be selected by user input received by the portable shopping device 102. In another embodiment, the first recipe is selected by shopping cart application module 104 in response to the current location of the portable shopping device 102 in the store. For example, if the portable shopping device 102 is in a baking goods aisle of a grocery store, shopping cart application module 104 could be configured to display a plurality of recipe photos and/or recipe titles for recipes including baking ingredients. The shopper then uses the portable shopping device 102 to select the first recipe from among the displayed recipes. In another embodiment, the shopping cart application module 104 may send a recipe photo and recipe to the portable shopping device display 200, which is then shown as a first recipe photo 408 as shown below in FIG. 4.

In the determine location step 302, the shopping cart application module 104 determines where in the store the portable shopping device 102 is located. The location may be determined at intervals, or may be continually updated. In some embodiments, the portable shopping device 102 is mechanically coupled to the shopping cart 106 so that the light sensor 210 (or camera if a separate camera is included in the portable shopping device) of the portable shopping device 102 reads a stationary light sensor or an encoded visual symbol, such as a QR code, located in various locations around the store. When the light sensor 210 recognizes the symbol, the location is updated to match a location associated with the symbol. The current location then remains the same until the portable shopping device 102 has moved enough to recognize a different symbol associated with a different location, at which time, the current location is updated in the shopping cart application module 104.

In some embodiments, the non-transitory memory 206 includes a store map, and shopping cart application module 104 is configured to correlate the light sensor 210 with an associated location on the store map.

In some embodiments, the current location can be further fine-tuned by using the optional elements such as the accelerometer gyroscope, and/or compass, to track the position of the portable shopping device 102 in the store when the shopping cart 106 has moved away from one encoded visual symbol, such as a QR code, but has not yet recognized the next symbol. The plan location of the portable shopping device 102 can then be continuously determined and indexed to the store map. The portable shopping device 102 updates a store database 1124 and the store management module 1108 database reads from there.

The location of the portable shopping device 102 can be repeatedly sent to shopping cart application module 104 so that the shopping cart application module 104 has data regarding the locations of all portable shopping devices 102 currently in use in the store.

The shopping cart application module 104 can also send additional data to the portable shopping device 102 based on the current location, for example advertisements and/or coupons.

In the next display information step 306, information about the first recipe photo 408 and a recipe information screen 406 are displayed on the portable shopping device display 200. An exemplary display 400 is described further below in FIG. 4. The process then returns to the determine location step 302, and the display 200 continues to update as the location changes.

Referring next to FIG. 4, an exemplary default recipe information display 400 of the In-Store Portable Location-Aware Shopping and Merchandising System 100 is shown in accordance with one embodiment of the present invention. In this default mode, the portable shopping device 102 displays two recipe photos. Shown are the first recipe photo 408, and a second recipe photo 410, a first recipe photo title 402, and a second recipe photo title 404, the recipe information screen 406 (including 3 tabs, “Nutrients” tab 430, “Ingredients” tab 432 and “Directions” tab 434), and a set of exemplary control icons. Exemplary control icons may include a “Help” icon 412 that brings up a brief training video; a “Text” icon 414 that brings up a dialer, allowing user to input a phone number to text a coupon; a “List” icon 416 that displays a shopping list of recipe ingredients that have been added to the shopping list using the “Add All” Icon 428; a store “map” icon 418 that replaces first and second recipe photos 408, 410 with a map of the store; a recipe photo scrolling start/stop or “Play/Pause” control button 420; “Low Cost” icon 422 searches a store product database for the lowest cost product option for selected recipe ingredients; “Low Calorie” icon 424 searches the store product database for the lowest calorie products of the recipe ingredients displayed by the “List” icon 416; and a “search” icon 426, that opens a touch keyboard for text entry and searches the store product database for matches in a. The store product database is custom-built for each store, and serves as the store directory. The store product database may be stored in the store database 1124 as described below in FIG. 11, or may be stored in another portion of the store system 110 suitable for access by the searches.

Prior to a selection of a recipe, the first recipe photo 408 and second recipe photo 408 are displayed as part of a continuous horizontal scrolling display, i.e. the displayed recipe photos are replaced with different recipe photos. The user may control the scrolling using the “Play/Pause” control button 420, whereby the scrolling (“playing”) of the recipe photos is toggled on or off

Each recipe photo 408, 410 corresponds to a recipe stored in the recipe database 1126. Each recipe photo 408, 410 is displayed for a period of time before being replaced by the different recipe photo. At any time, the user may select one displayed recipe photo. The recipe corresponding to the selected recipe photo is the selected recipe. Additionally, the continuous scrolling ceases after selection of the selected recipe photo. Two recipe photos 408, 410 are simultaneously displayed in the exemplary display 400, but it will be understood that other numbers of recipe photos may be displayed simultaneously.

The display 400 shown in FIG. 4 is an exemplary display after the first recipe photo 408 has been selected. In response to the selection, the selected recipe information corresponding to the recipe associated with the first recipe photo 408 is displayed. The first recipe photo title 402, the first recipe photo 408, and the recipe information screen 406 are displayed on the portable shopping device 102. The recipe information screen 406 contains 3 tabs defaulting to the “NUTRIENTS” tab 430 The “Nutrients” tab 430 displays the recipe corresponding to the first recipe photo 408 including number of servings, portion cost, cook and prep times, and nutritional information such as calories, carbohydrates, saturated fat, sugar and protein per serving. The “INGREDIENTS” tab 432 displays ingredients that the system adds to the shopping list, if the “Add All” icon 428 is touched. The “DIRECTIONS” tab 434 displays the preparation directions for the first recipe photo 408 recipe. The first recipe photo title 402, and the first recipe photo 408 recipe is included in the recipe database 1126 for each recipe selected by shopping cart application module 104 based on current shopper location/zone.

The display 400 also includes the second recipe photo 410 and title the second photo title 404. In some embodiments, the shopper can select by touch another recipe photo to add another recipe from shopping cart application module 104 and display the second recipe photo 410 and second recipe photo title 404 in addition to those for the first recipe. The user can then select the second recipe instead of the first recipe.

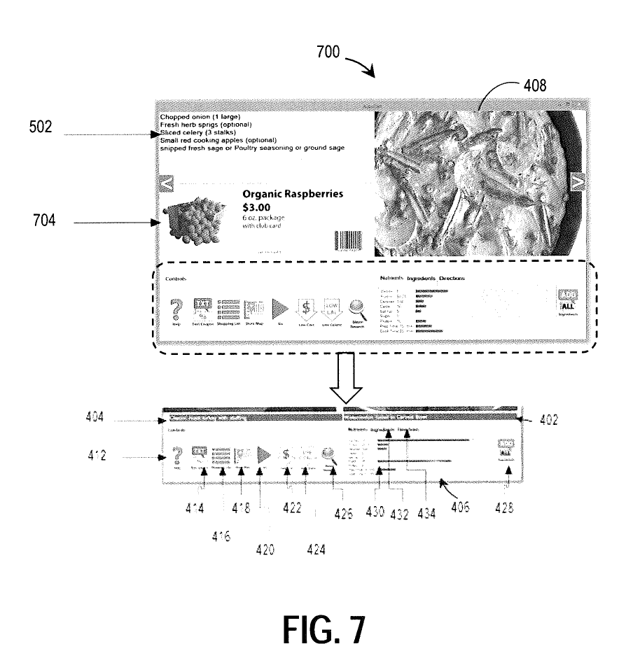

Advertisements are assigned to zones and display upon entry into that zone. Stopping on one recipe by touching the photo may also embed an advertisement and/or coupon 704 on screen, in exemplary embodiment of the experiment, in the second recipe photo 410 as shown below in FIG. 7.

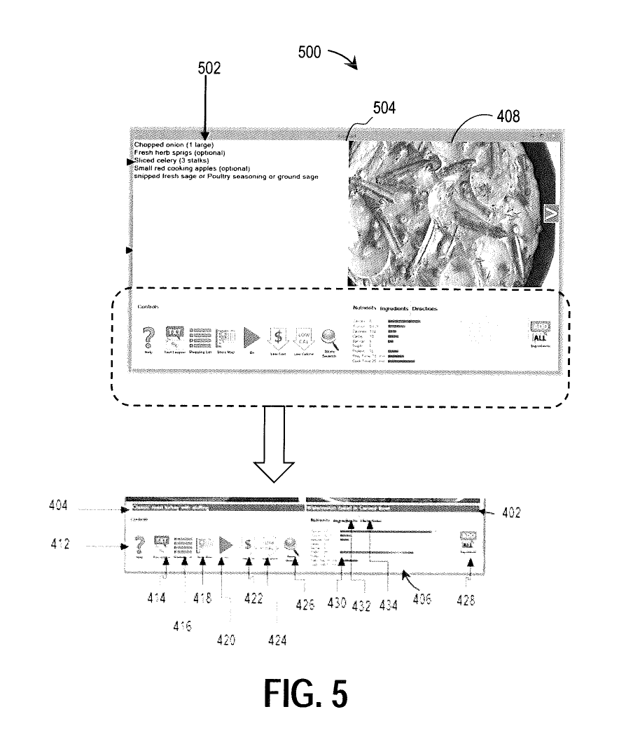

A series of control menu icons are shown along a bottom left-hand portion of the display 400. The control icons include the “Text” icon 414. Selection of the “Text” control icon 414 will send a message to a phone number corresponding to a mobile phone device (in one embodiment the mobile device 108). Selecting the “List” icon 416 displays the shopping list (as shown below in FIG. 5). Selecting the “Play/Pause” icon 420 stops the recipe photos from scrolling and allows the user to restart the recipe photo scrolling. Additional icons may be added in other embodiments of the display 200, for example an email icon which when selected emails information to an email address input via the display, and/or a “delete all” icon, which when selected causes all items to be deleted from the current shopping list.

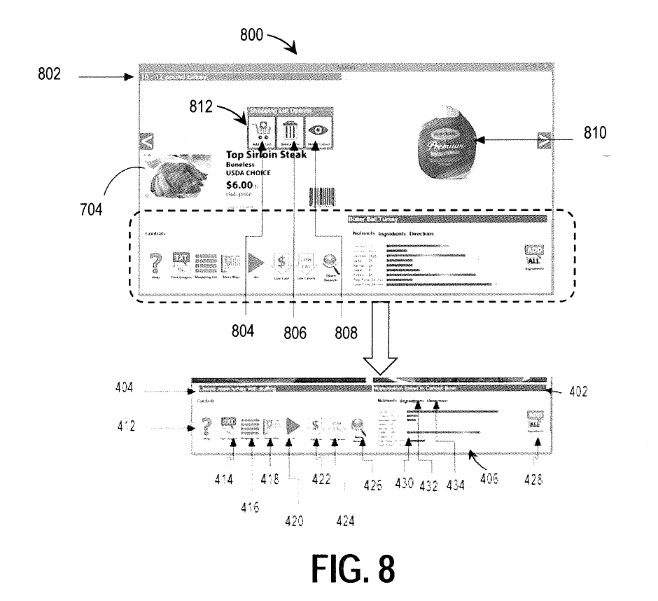

Referring next to FIG. 5, an exemplary recipe Ingredient to Shopping list display 500 of the portable shopping device 102 is shown in one embodiment of the present invention. Shown are the first recipe photo 408, the first recipe photo title 402, the recipe information screen 406, and a scroll bar 504 for an ingredient list 502. The exemplary ingredient list 502 will include each item description with quantity, and a unit of measurement. An exemplary “Shopping List Options” user input interface allows the shopper to delete one or more items from the ingredient list 502 as explained below for FIG. 8.

In the embodiment of the display 500 shown in FIG. 5, the recipe information screen 406 including information about the currently selected recipe first recipe photo 408 (in FIG. 5 designated as the list recipe) is displayed on the portable shopping device 102. The list recipe photo 408 and the recipe information screen 406 are displayed on a right-hand side of the display 500, as in FIG. 4. Also as in FIG. 4, the row of control icons 412, 414, 416, 418, 420, 422, 424, 426 are displayed along the lower left-hand side of the display 500. An upper left-hand portion of the display 500 shows the ingredient list 502 corresponding to the selected (list) recipe. The list comprises a table with one row for each ingredient of the list recipe. If the number of rows and/or columns exceeds the display area available for the ingredient list 502, the display 500 can provide one or two scroll bars 504 for scrolling to additional table elements. In the exemplary display 500, a vertical scroll bar 504 is provided indicating that additional rows are available to view. In other embodiments, a horizontal scroll bar may be provided.

The ingredient list 502 may in some embodiments include a table header as a top row in the ingredient list 502, indicating to the shopper what information is shown in the ingredient list 502 on the top left of the display 500. For example, the exemplary ingredient list 502, could show a recipe item description with quantity (indicated by the text “Description” in the table header), a unit of measurement column (indicated by the text “UM” in the table header), etc. It will be appreciated by those of ordinary skill in the art that additional columns of information may be shown, or columns substituted for other information.

As discussed further below, a plan area of the store is divided into regional shopping zones. Each ingredient is mapped to one or more shopping zones. In one embodiment, Ingredient to Shopping list display 500 is updated as the portable shopping device 102 traverses the store, so that only the ingredients located in the current shopping zone are displayed.

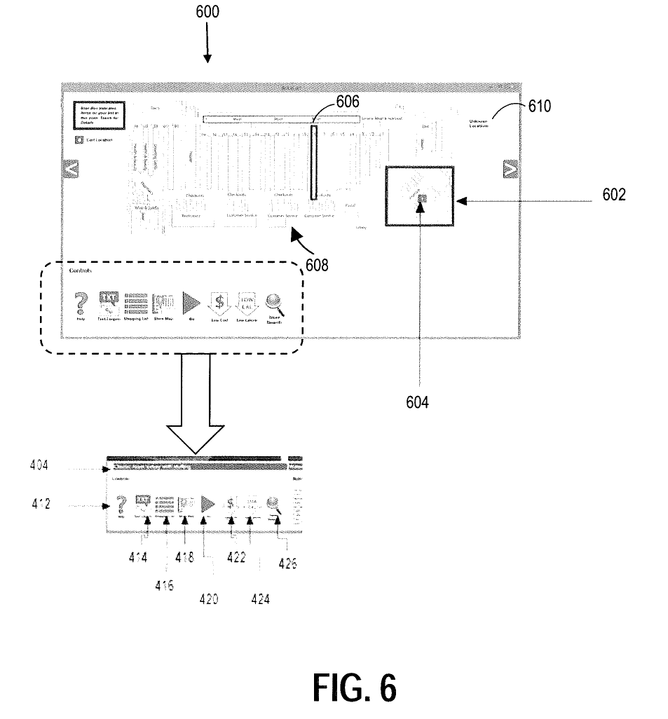

Referring next to FIG. 6, an exemplary store map display 600 of the portable shopping device 102 showing a store map 608 is shown. Also shown are a first zone border 602, a second zone border 606, and a cart location symbol 604. In some embodiments, when the shopper touches the store “map” control icon 418, the store map replaces the second recipe photo 410 and the first recipe photo 408 with the store map display 600. The borders 602, 606 represent store zones that contain products added to the shopping list. The line of the borders 602, 606 bordering the zone appears bolder (wider) the more products in the shopper's current store zone. In this exemplary implementation, the zone borders 602, 606 are in blue to contrast them to the black and white used for internal store fixtures and general map notations. The map also includes an indication 610 in the upper right corner of the display 600 that represents products that do not have a valid store location. A “Store Zone” is a physical region within the store that contains a collection of products. A zone can represent any region of the store. The aisle or departments will typically represent the store zones. Store Zones are mapped to Industry Standard Zones with a unique many-to-many representation. First zone border 602 represents the entire area of the store that is contained in that area of the store. The cart location symbol 604 indicates the physical location of the cart at the time of display. The cart location symbol 604 is analogous to the “You Are Here” symbol found on many maps for large shopping venues.

Referring next to FIG. 7, an exemplary store zone recipe ingredients display 700 of the portable shopping device 102, that shows the ingredient list 502 and coupon 704. This display 700 is triggered by physical entry of the cart 106 into the corresponding zone within the store or when the shopper touches (“clicks”) on the zone on the Store Map Display 600 (FIG. 6). The first recipe photo 408 at this point will only display a recipe photo containing ingredients located in the shopper's current store zone. If the shopper selects the “text” icon 414, the coupon 704 shown will be the coupon sent via text to the phone number entered on a Mobile Phone Number Keypad Entry overlay dialog box 916. The ingredient list 502 lists the ingredients located in this zone that were added from the selected recipe. Rotating coupons 704 may be shown on the display 700 for products located in the zone where the shopper is located. It will be appreciated by those of ordinary skill in the art that additional ads, recipes, and information screen may be shown, or substituted for this exemplary design as screen resolution and I/O interface technologies evolve.

Referring next to FIG. 8, shown is an exemplary selected product display 800 of the portable shopping device 102 including a Selected Product picture 810 corresponding to at least one store zone ingredient 802. This selected product display 800 is triggered when the shopper touches or clicks on one item of the ingredient list 502. In response to the ingredient selection, only ingredients available in the current store zone location are shown. For example, in FIG. 8 the portable shopping device 102 is located in a meat zone, the ingredient list 502 includes one ingredient located in the meat zone: turkey. In response to the selection the ingredient list 502 is filtered to show only the subset of recipe ingredients located in the meat zone: the at least one store zone ingredient 802. The selected product picture 810 of the turkey is shown.

The product associated with each store zone ingredient 802 is matched to a final Universal Product Code (UPC) with either a preset UPC associated with the recipe ingredient default or the UPC from the “Low Cost” Icon 422 or “Low Calorie” Icon 424 algorithm. When the shopper selects, for example, the “Low Cost” Control Icon 422, a UPC previously associated to the ingredient as a low cost product is identified. A shopping list options window 812 is included in the selected product display 800. The shopping list options window 812 includes an add to cart icon 804, a delete item icon 806, and a view product icon 808. Touching the add to cart icon 804 adds the selected product corresponding to the store zone ingredient 802 to the shopping list and removes the added product from the at least one store zone ingredient 802 and the selected product picture 810. Touching the delete item icon 806 deletes a selected product from the shopping list and removes the selected store zone ingredient 802 from the display 600 of FIG. 6. Touching the view product icon 808 displays the selected product picture 810, associated with the selected store zone ingredient 802, on the right side of the screen, to assist shopper in finding the exact product specified in the recipe.

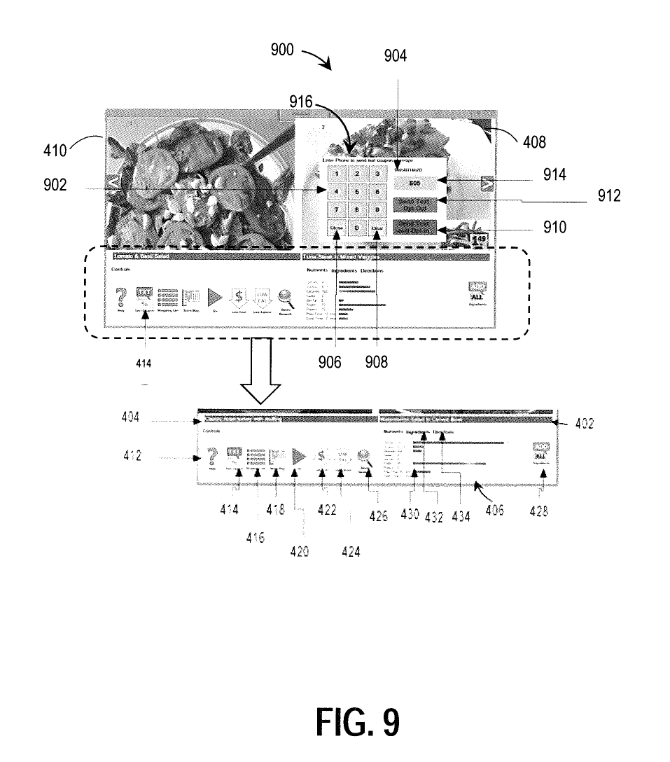

FIG. 9 depicts an exemplary keypad entry display 900 of the portable shopping device 102 including the exemplary Mobile Phone Number Keypad Entry overlay dialog box 916 is an interface used for the shopper to text a coupon image and barcode to the optional mobile device 108 for scan during checkout. The Mobile Phone Number Keypad Entry overlay dialog box 916 is triggered when the shopper touches the “Text” icon 414. The coupon image is sent in a text message (typically MMS rather than SMS). A function of the shopping cart application module 104 called by selection of the “Text” icon 414 will send to a phone number corresponding to a mobile phone device (in one embodiment the mobile device 108). The phone number is entered by touching a keypad 902 of the Mobile Phone Number Keypad Entry overlay dialog box 916, whereby the entered phone number is displayed in a phone number display 904. For convenience, an area code icon 914 may be provided, whereby when the shopper touches the area code icon 914, an area code indicated by the area code icon 914 is entered in the phone number display 904. In the exemplary area code icon 914, the entered area code would be ‘805’. When the phone number is entered, the portable shopping device 102 sends to the corresponding device an image of a promotional coupon for the zone that the cart 106 is physically located in, along with a URL link to one or more recipes being displayed at the time of the send. The “Text” icon 414 initiates this interactive display, see FIG. 4 for additional discussion. A “Close” button 906 of the Mobile Phone Number Keypad Entry overlay dialog box 916 is touched by the shopper to close the Mobile Phone Number Keypad Entry overlay dialog box 916 and return to normal cart operation as shown in FIG. 4. The “Clear” button 908 clears the phone number display 904 so the shopper can enter another phone number using the keypad 902.

A “Send Text and Opt-in” icon 910 performs the actual send and adds the phone number to an opt-in list that is recorded by the portable shopping device 102 allowing use of this phone number later for future offers. The “Send Text Opt-out” icon 912 also performs the actual send, but the entered phone number is not recorded in the database for future use.

The “Send Text and Opt-in” icon 910 and “Send Text and Opt-out” icon 912 only appear when a full phone number (i.e. including area code) has been entered. The opt-in process is a two-step process, in that the shopper must receive the content and verify their opt-in for future use of the mobile phone number.

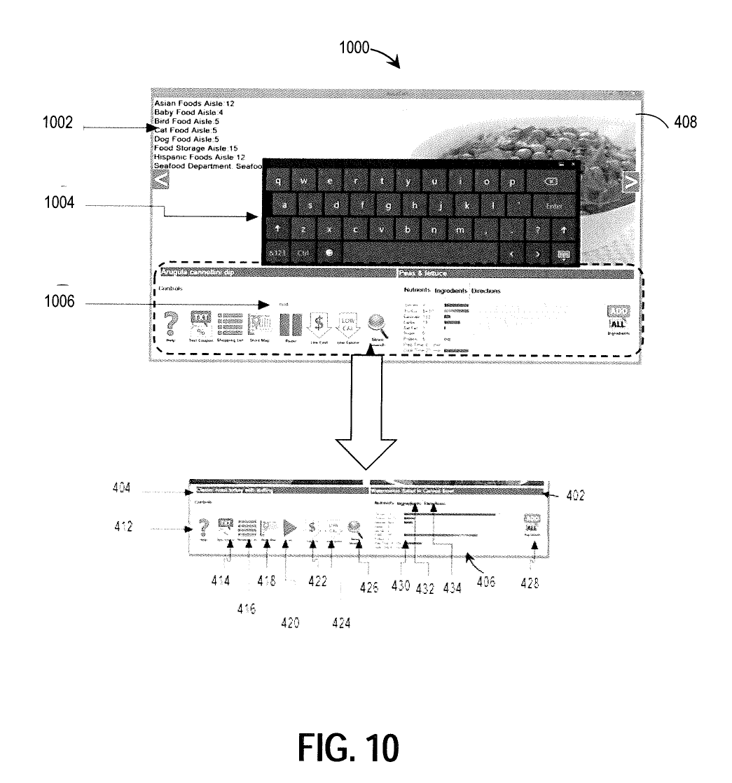

Referring next to FIG. 10 an exemplary keyboard overlay display 1000 of the portable shopping device 102 including a search interface keyboard overlay 1004 is shown. The search interface keyboard overlay 1004 is activated when the shopper invokes the “Search” icon 426 by touching it. The search interface keyboard overlay 1004 allows the shopper to input search text to search the store product database, including product entries associated with store zones, for the current physical store. The store product database is different for every store and includes a unique store number to isolate the particular store where the portable shopping device 102 is to be used.

Text entered using the search interface keyboard overlay 1004 is displayed in the search window 1006. In the exemplary display 1000 of FIG. 10, the shopper has entered the text ‘food’ using the search interface keyboard overlay 1004, which is then displayed in the search window 1006. In response to the entering of text, the store product database is searched using the entered text, and a corresponding search item list 1002 of matching directory entries from the store product database is displayed. The search item list 1002 includes each matching item in the store product database where the description of the item contains the search term entered by the user in the search window 1006. The search interface keyboard overlay 1004 is activated and displayed when the shopper touches the “Store Search” icon 426. The text entered by the shopper appears in the search window 1006 when keyboard buttons of the search interface keyboard overlay 1004. It will be appreciated by those of ordinary skill in the art that newer I/O interface technologies will evolve and potentially be adapted in lieu of the present exemplary embodiment of the invention.

Referring finally to FIG. 11, an exemplary embodiment of a high-level process and database schematic diagam 1100 is shown for the Portable In-Store Shopping and Location-Aware Shopping and Merchandising System 100. The shopping and merchandising system 100 uses a current location (i.e. current zone) of the portable shopping device 102 to determine which advertisements to display. The system schematic diagram 1100 includes the portable shopping device 102, the shopping cart application module 104, the store system 110, the light sensor 210, a cart master update module 1104, the store management module 1108, a store zone database 1110, a merchandise plan 1112 including advertising campaigns, a shopping list table 1116, a store zones to advertiser zones table 1120, an advertising system 1122, the store database 1124, and the recipe database 1126.

The shopping cart application module 104 is included in the portable shopping device 102 as previously shown in FIG. 1. All of the FIG. 2 sub-components (the display 200, the communication module 202, the processor 204, non-transitory memory 206, the shopping cart application module 104, and the light sensor 210) are represented by the portable shopping device 102. The light sensor 210 is in a perpetual loop updating the cart master update module 1104 with the current location of the cart 106 within the store. The store system 110 interfaces with the cart master update module 1104 via the light sensor 210 in order to send information to the portable shopping device 102 based on the zone (location) of the portable shopping device 102 (as previously described in FIG. 3) and drives the logic of the display 200 controlled by the shopping cart application module 104, shown previously in FIG. 1 and FIG. 2.

The store system 110 includes a plurality of elements, including the cart master update module 1104, the store management module 1108, the store zone database 1110, the merchandise plan 1112, the shopping list table 1116, the store zones to advertiser zones table 1120, the advertising system 1122, the store database 1124, and the recipe database 1126. The store system 110 elements may be stored locally or remotely, as long as the shopping and merchandising system 100 elements are communicatively coupled in order to receive and/or send the data and other information in order to complete the required functions. In some embodiments, one or more store system 110 elements may reside on the portable shopping device 102, for example the cart master update module 1104.

The recipe database 1126 interacts with the store zones to advertiser zones table 1120, via the merchandise plan 1112, based on product UPCs, and return advertisements (wherein each advertisement is associated with at least one location) from the advertising system 1122, such as banners and full size ads, to the shopping cart application module for display on the portable shopping device 102, based on the location of the portable shopping device 102.

The shopping cart application module 104 includes a connection to the store database 1124 and processing logic that drives the shopping cart application module 104 interface to select the recipes from the recipe database 1126 and related information such as the shopping list 1116 for the shopper.

The store management module 1108 provides access to the store database 1124 organized in a usable fashion. The store management module 1108 summarizes views of the cart location (as indicated by the cart location symbol 604 in FIG. 6) and zone borders (e.g. the first zone border 602 and the second zone border 606 in FIG. 6).

The store zone database 1110 contains transactional data from the shopping cart application module 104 including detailed travel path, recipes, and advertising shown to the shopper. Data is sampled on a timed schedule. The store zone database 1110, also includes the data that describes the physical zone locations within the store along with products, related recipes, and advertisements.

The merchandise plan 1112 includes items that are to be presented to the shopper when they are within a specific zone, such as the Organic Raspberries advertisement and coupon 704 presented in FIG. 7. A product advertisement not including a coupon may alternately be presented. Each zone is a physical location within a store with geo-fences that trigger movement to another part of the merchandise plan 1112. The merchandise plan 1112 allows the portable shopping device 102 to display recipes, products, and advertising when located in that physical area of the store and change to a different merchandising plan in a different zone.

The recipe database 1126 contains the ingredients, nutrients, and preparation instructions to convert products in the store into meals that can be served to the family. The recipe database 1126 supports conversion of the ingredients to specific product UPCs through the store product database stored in the store database 1124 or other suitable location in the system 110. The store product database includes multiple products linked to recipe ingredient items, where the different products match different ingredient requirements, as described previously. For example, products matching the criteria “low cost” or “low calorie” may be selected from the list of products associated with the ingredient. This logic structure allows the shopping and merchandising system 100 to find the optimal products in the store based on price, nutrient values, or other criteria.

The shopping list table 1116 represents all the items from each recipe that the shopper has selected and did not remove. The shopping list table 1116 is displayed when the “shopping list” icon 416 is touched. All recipe ingredients are added to the shopping list table 1116 using the “Add All” Icon 428. The shopper also has the option to remove any item not needed at home.

The Store Database 1124 includes transactional data including the detailed history from the shopping cart application module 104 contained within the portable shopping device 102, including display status and any user interactions along with the physical location, date, and time. The store database 1124 transactional data serves as the history of the cart transactions and the documentation of billing that connects to the advertising system 1122.

The store zones to advertiser zones 1120 allows the portable shopping device 102 to operate based on zones in the physical store and connects to advertising zones used to target the advertising placement within the stores. This creates a unique many-to-many relationship between the two different types of zones. It allows an advertiser to place an ad in a generic zone such as “Dairy” even when the store places dairy items in several different locations in the store. A single area within a store, such as an aisle, can be related to multiple generic advertising zones and in store level unique combinations.

The advertising system 1122 allows advertisers to place ads within the system 100 to be delivered as the shopper enters a specific store zone.

As previously described in FIG. 3, the process of using the portable shopping device 102 includes the light sensor 210 (in one embodiment a camera) repeatedly taking photographs in response to time events within the shopping cart application module 104, set by a value in a policy table of the shopping cart application module. Each picture is processed to isolate known visible markers within the store. In one embodiment, a label is affixed to a bottom rail of a shelf within the store and data on the label includes the unique location identification. Using the unique location identification, a marker x,y axis location is retrieved from the store zone database 1110, resetting to the new location. The light sensor 210 generates data based on the movement of the shopping cart 106, and the cart master update module 1104 updates the x,y axis location based on the data. With each cycle, the cart master update module 1104 is updated with the new x,y axis location, translated using the store zone database 1110 to identify the current zone. Store zone areas, such as those represented by the first zone border 602 and the second zone border 606 as shown in FIG. 6, contain the x,y axis points, plus the width and height of the zone, expressed in pixels scaled to the store map 608. The store zones translate to the advertiser zones through a unique many-to-many relationship supported by the store zones to advertiser zones table 1120. In this way, each store can have a class of products like “Dairy” in different or even multiple locations that become combined for the advertiser who just purchased dairy as a placement zone.

The shopping cart application module 104 can be configured to match one or more of the store zones with advertising zones linked to external advertisers. The advertisers can then place ads in advertising zones that are then automatically linked to the store zone, and ultimately displayed on the portable shopping device 102 when it is located within that zone.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. An in-store location-aware shopping and merchandising system comprising:
a portable shopping and merchandising device comprising:
a processor;
a non-transitory memory coupled to the processor;
a shopping cart application module configured to run on the processor;
at least one light sensor;
a communication module communicatively coupled to the shopping cart application module and the at least one light sensor; and
a display operatively coupled to the shopping cart application module, wherein the shopping cart application module is configured to perform the steps of:
determining a current location of the portable shopping and merchandising device;
receiving information about at least one store item, wherein each store item is associated with at least one location; and
displaying on the display information about at least one of the at least one store item, wherein at least one of the at least one store item is associated with the current location.

2. The in-store location-aware shopping and merchandising system of claim 1, wherein the display is a touchscreen.

3. The in-store location-aware shopping and merchandising system of claim 1, wherein the current location is determined at least in part by data received by the at least one light sensor.

4. The in-store location-aware shopping and merchandising system of claim 3, wherein the at least one light sensor includes a camera, and wherein the current location is determined by the camera taking a photograph of an encoded visual symbol.

5. The in-store location-aware shopping and merchandising system of claim 3, wherein at least one of the at least one light sensor is selected from a group consisting of a camera, a photo transistor, and a charge-coupled device.

6. The in-store location-aware shopping and merchandising system of claim 1, wherein the shopping cart application module is configured to receive and display a store map on the display.

7. The in-store location-aware shopping and merchandising system of claim 6, wherein the store map is updated by at least one external computing device.

8. The in-store location-aware shopping and merchandising system of claim 6, wherein the display of the store map includes displaying of an indication for at least one of the least one store item, wherein each displayed indication indicates at least one location associated with the at least one store item.

9. The in-store location-aware shopping and merchandising system of claim 1, wherein the information includes at least one recipe wherein at least one store item is an ingredient in the at least one recipe.

10. The in-store location-aware shopping and merchandising system of claim 9, the shopping cart application module further configured to display an ingredient list for the at least one recipe.

11. The in-store location-aware shopping and merchandising system of claim 1, further comprising a mobile computing device communicatively coupled to the portable shopping and merchandising device.

12. The in-store location-aware shopping and merchandising system of claim 11, wherein the mobile computing device is configured to send a recipe to the portable shopping and merchandising device, and wherein the portable shopping and merchandising device is configured to store the recipe on the non-transitory memory.

13. The in-store location-aware shopping and merchandising system of claim 1, the shopping cart application module further configured to perform the steps of:
receive at least one advertisement associated with at least one location; and
display the at least one advertisement on the portable shopping and merchandising device wherein at least one of the at least one advertisement is associated with the current location.

14. The in-store location-aware shopping and merchandising system of claim 1, wherein the portable shopping and merchandising device is mechanically coupled to a shopping cart.

15. A method for using an in-store location-aware shopping and merchandising system comprising the steps of:
determining a current location of a portable shopping and merchandising device, the portable shopping and merchandising device including a processor, a non-transitory memory coupled to the processor, a shopping cart application module configured to run on the processor, at least one light sensor, a communication module communicatively coupled to the shopping cart application module and the at least one light sensor, and a display operatively coupled to the shopping cart application module;
receiving, by the portable shopping and merchandising device, information about at least one store item, wherein each store item is associated with at least one location; and
displaying on the display information about at least one of the at least one store item, wherein at least one of the at least one store item is associated with the current location.

16. The method for using the in-store location-aware shopping and merchandising system of claim 15 further comprising the steps of:
receiving at least one advertisement associated with at least one location; and
displaying the at least one advertisement on the portable shopping and merchandising device wherein at least one of the at least one advertisement is associated with the current location.

17. The method for using the in-store location-aware shopping and merchandising system of claim 15 further comprising the step of:
displaying of a store map on the display.

18. The method for using the in-store location-aware shopping and merchandising system of claim 17, wherein the display of the store map includes displaying of an indication for at least one of the at least one store item, wherein each displayed indication indicates at least one location associated with the at least one store item.

19. The method for using the in-store location-aware shopping and merchandising system of claim 15, wherein the information includes at least one recipe wherein at least one store item is an ingredient in the at least one recipe.

20. The method for using the in-store location-aware shopping and merchandising system of claim 19, the shopping cart application module further configured to display an ingredient list for the at least one recipe.
